(19) United States
(12) Patent Application Publication
(10) Pub. No.: US 2013/0092333 A1
(43) Pub. Date: Apr. 18, 2013

(54) TUBULAR GEARMOTOR WITH FIXING SUPPORT

(71) Applicant: NICE SPA, Oderzo (Treviso) (IT)

(72) Inventors: Andrea Malausa, Ponte di Piave (TV) (IT); David Gerlin, Santa Lucia di Piave (TV) (IT)

(73) Assignee: NICE SPA, Oderzo (Treviso) (IT)

(21) Appl. No.: 13/650,340

(22) Filed: Oct. 12, 2012

(30) Foreign Application Priority Data
Oct. 12, 2011 (IT) TV2011A000139

(51) Int. Cl. E06B 9/68

(52) U.S. Cl. CPC E06B 9/68
USPC 160/368.1

(57) ABSTRACT

A tubular gearmotor for curtains, shutters, roller blinds or the like, comprises a support which is suitable for being fixed to a support surface and which receives a head of the tubular gearmotor which can be inserted in an insertion direction substantially coinciding with the axial extension of the gearmotor. The support is provided with means preventing the axial rotation of the head and with releasable-engagement means for preventing axial extraction of the head. The releasable-engagement means comprise locking/fixing members which are circumferentially distributed around the axis for insertion of the head and which are each movable between a first engaging position and a second disengaging position. An actuating member is also provided, said actuating member, when manually operated, performing the displacement of the locking/fixing members between the first and the second position.

The present invention relates to a tubular gearmotor of the type used for driving curtains, hinged shutters, roll-up shutters, roller blinds and the like.

As is known, the tubular gearmotors used to provide the driving movement for curtains, roll-up shutters, hinged shutters, roller blinds, etc., are usually inserted inside the winding tube and transmit to it the rotational movement by means of a pulley, or “adaptor”, which is mounted on the output shaft situated at the end of the gearmotor on the inside of the winding tube. The other end of the gearmotor, or “head”, is situated on the outside of the winding tube and must be fixed to a surface or wall, such as a wall or the side of a housing, by means of a suitable metal or plastic support. This support must have a suitable strength so as to be able to support the weight of the roller blind and withstand the stresses which are imparted by the driving movement and which may also be relatively high, both in terms of twisting moment and as regards axial traction.

The support must, however, also allow removal of the gearmotor itself in the event of faults or other needs. Over time, therefore, various types of releasable connections have been proposed, said connections making use of ordinary screws, clips, pins or specific mechanical means.

It is preferable, however, that both assembly and disassembly of the gearmotor on the support should be easy, fast and uncomplicated. In particular, in the case of drive systems which are inserted inside small spaces, as in the case of housings or the like, assembly and removal are critical operations owing to the small amount of room available for the assembler to reach and operate the fixing systems.

In EP 0468925 in the name of Somfy it is proposed for example the use of a support for the head of the gearmotor which is substantially star-shaped and has a matching seat in the support element which is fixed to the wall. Locking of the rotational movement of the head with respect to the support is thus ensured by means of a form-fit between the projections on the support and the respective recesses in the external surface of the head.

The head is then fixed inside the support by means of a resilient metal ring which is housed inside a seat suitably formed along the outer perimeter of both head and support, thus preventing mutual extraction of the two parts.

The locking ring must be manually inserted and/or rotated by the person performing installation after inserting the head of the gearmotor inside the support. Using the reverse procedure, the head may be extracted from the support after removing the metal ring.

The action which the user must perform in order to operate the resilient metal ring and the space required for operation are, however, critical for correct, easy and fast assembly of a roller blind. In particular, if the roller blind is located in an awkward, cramped or dangerous position, or if a large number of roller blinds must be assembled, assembly of the aforementioned system is difficult and relatively time-consuming, while subsequent disassembly may take even longer and be even more difficult. For example, the ring has dimensions which are larger than the external dimensions of the support (it must fit over the outside thereof) and therefore, a cramped operating spaces allow to position the ring in the correct position so as to able to push it into the seat (it must be positioned at right angles to the support and head assembly). Moreover, easy gripping of the resilient ring facilitates the ring insertion and extraction operation. The situation becomes even more critical when disassembly must be performed a long time after installation, since the accumulated dirt and dust make it difficult to locate and operate the locking ring.

Moreover, it is always required to use tools and this makes operation of the locking means even more awkward and difficult.

A further disadvantage of the known systems is that the fixing operation always requires an active effort on the part of the person performing installation, with the risk that an oversight may also result in dangerous situations, with the entire drive structure suddenly coming loose and falling.

In fact, considering for example the teaching of EP 0468925, the operator, after inserting the head inside the support, must insert correctly the ring inside the seats in order to ensure locking of the parts and the correctly locked condition often cannot be immediately determined.

The object of the present invention is therefore to overcome the drawbacks of the prior art by providing a tubular gearmotor which is equipped with a support having a simple locking/unlocking mechanism, is strong and reliable and allows easy, rapid and correct locking/unlocking in the various operating conditions.

In view of this object, the idea which has occurred according to the invention is to provide a tubular gearmotor for curtains, shutters, roller blinds or the like, comprising a support suitable for connecting the head of the tubular gearmotor to a support surface.

The support intended to be fixed to the support surface receives the head of the gearmotor in an insertion direction which coincides substantially with an axial extension of the gearmotor. The support is provided with means for preventing rotation of the head and with releasable engaging means for preventing axial extraction of the head. The gearmotor is characterized in that the releasable engaging means comprise locking elements which are circumferentially distributed around the axis for insertion of the head in the support and are each movable between a first locking position and second unlocking position, and an actuating member movable with respect to said locking members, which, when manually operated, performs the displacement of the locking elements between the first and second position.

The characteristic features and advantages of the gearmotor provided in accordance with the principles of the invention will emerge more clearly from the description below of a number of examples of embodiment provided by way of a non-limiting example with reference to the accompanying drawings in which:

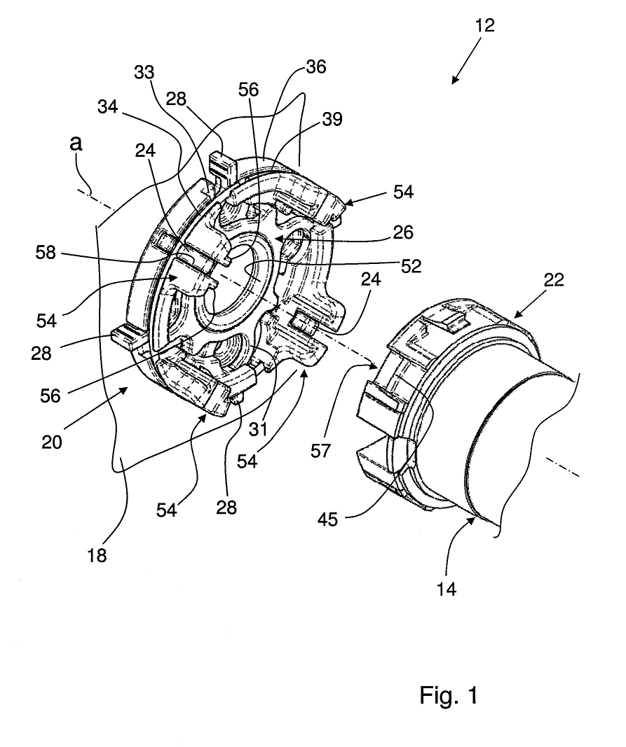

FIG. 1 shows a partial perspective and partially exploded view of a tubular gearmotor with support according to the present invention;

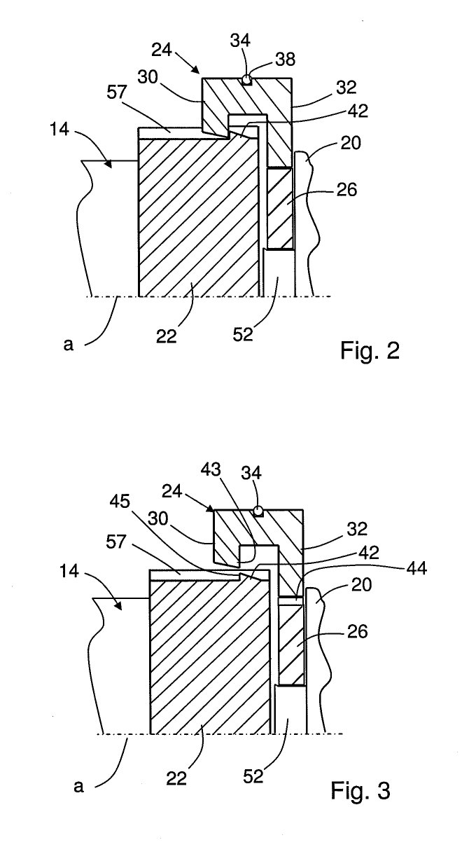

FIG. 2 shows a schematic and partial cross-sectional view of the support according to FIG. 1 in an engaged condition;

FIG. 3 shows a view similar to that of FIG. 1, but with the support in a disengaged condition;

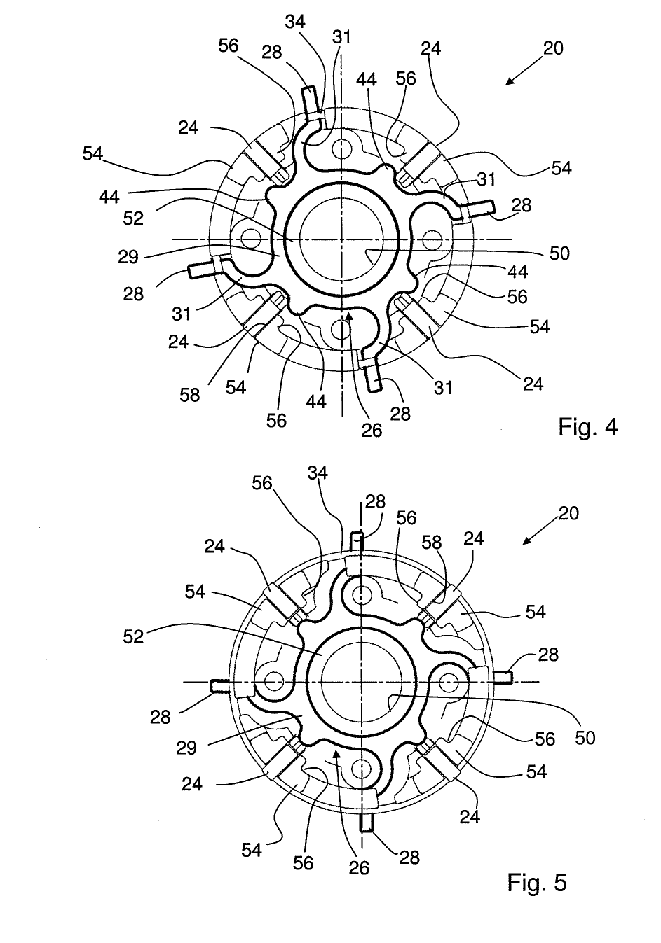

FIG. 4 shows a front view of a part of the support according to FIG. 1 in the engaged condition;

FIG. 5 shows a front view of a part of the support according to FIG. 1 in the disengaged condition;

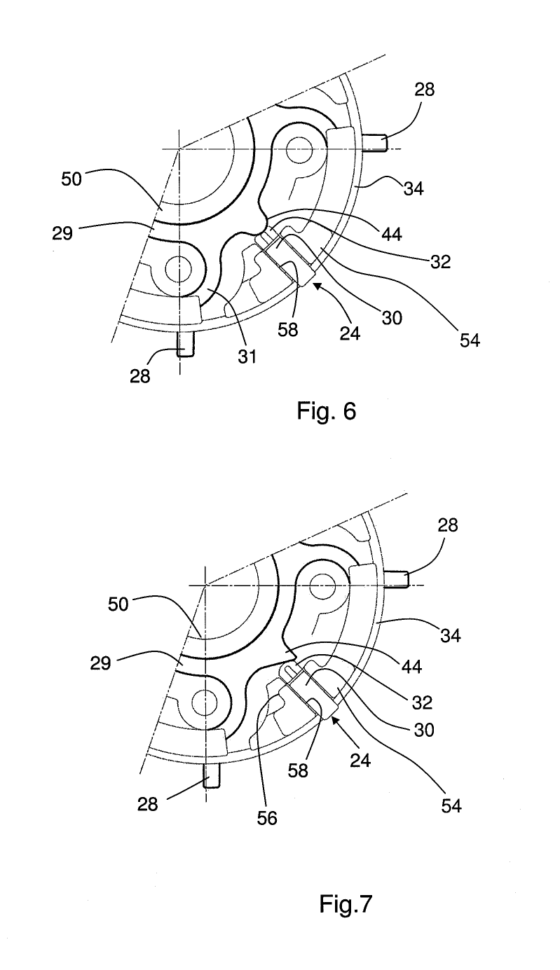

FIG. 6 shows a partial front view, on a large scale, of the support part shown in FIG. 5;

FIG. 7 shows a front view, similar to that of FIG. 6, but in the case of a constructional variant of the support according to the present invention;

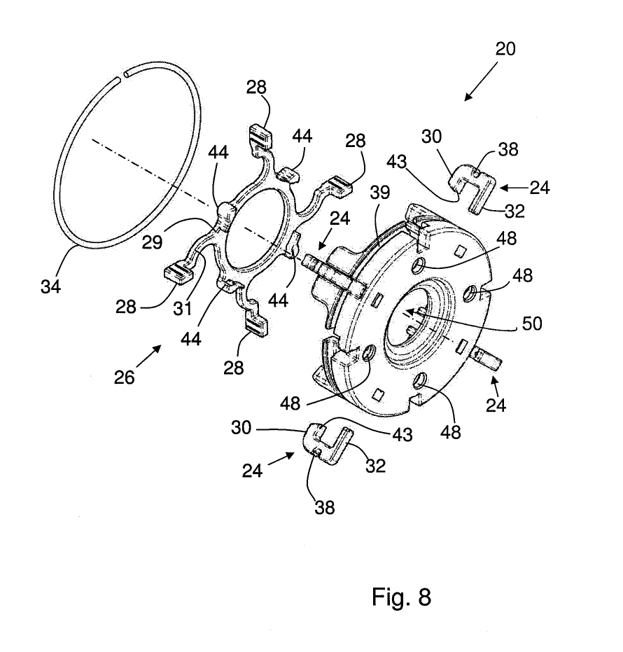

FIG. 8 shows an exploded, perspective, rear view of the support according to FIG. 1.

With reference to the Figures, FIG. 1 shows a tubular gearmotor (denoted generally by 12) provided in accordance with the present invention; said gearmotor comprises a support 20 and a known tubular gearmotor body 14 (shown only partially, being otherwise known for the person skilled in the art) of the type used for providing the driving movement for curtains, shutters, roller blinds, etc., and containing the known electrical drive system. The support 20 is intended to connect a head 22 of the gearmotor 14 to a support surface 18 (for example a wall or the inside of a housing).

In particular, the support 20 is intended to be fixed to the surface 18 so as to receive the engageable head 22 which is situated on the end of the body of the tubular gearmotor 14 which is usually inserted with its other end inside a suitable known winding tube (not shown).

Advantageously, the support 20 has a disk-shaped form and is provided with through-holes 48 (shown for example in FIG. 8) for fixing to the surface 18 via means known per se, such as screws (not shown). The support 20 and the head 22 can be coupled together by means of a movement towards each other along a direction which substantially coincides with the axial extension of the gearmotor, the longitudinal axis of which is denoted by ‘a’ in FIG. 1. This axis ‘a’ coincides with the axis of rotation of the roller blind and the tubular gearmotor 14 in the operating condition, which axis moreover coincides with the longitudinal axis of the support 20.

Advantageously, the support 20 (advantageously of circular shape) receives the head 22 and has first means for slidable coupling along the said direction of movement towards each other, which prevent relative rotation about said axis ‘a’. In particular, these means comprise protruding members 54 arranged along the perimeter of the support 20 and extending parallel to the axis ‘a’ in the direction opposite to the surface 18. These members 54 receive between them the head 22, or part thereof, so as to contain it laterally and each define surfaces 56 for locating against the side walls of the splines 57 formed along the outer perimeter of the head 22. Advantageously, the members 54 are four in number and are equally distributed along the circumference at about 90° from each other, but could also be different in number and differently spaced.

The protruding members 54, which are slidably inserted inside the splines 57, have the function of preventing any rotational movement of the head 22 of the gearmotor when the head 22 is inserted inside the support 20. Moreover, they guide insertion of the head 22 inside the support 20, facilitating engagement thereof. Advantageously, the holes 48 for fixing the support 20 to the support surface 18 may be situated on the inside of the protruding elements 54 or externally on the perimeter of the support itself.

As can be seen more clearly for example in FIG. 2, movable mutual locking or fastening means preventing axial extraction are arranged along the perimeter of the support 20. These means comprise advantageously sliding locking members or hooks 24 which are distributed circumferentially along the perimeter of the support 20 and which have surfaces 43 which make contact, in the direction of extraction of the head 22, against corresponding locating surfaces 45 present on the head 22. Advantageously, the hooks 24 are arranged on the support 20 and the surfaces 45 are formed on the head 22 at the end of an inclined tooth 42 projecting radially.

Obviously, with suitable modifications, the arrangement of the hooks 24 and the surfaces 45 may be reversed.

As can be clearly seen in the figures, the hooks 24 are advantageously slidable radially with respect to the axis ‘a’ (towards the outside of the support). Again advantageously, each hook 24 slides through a protruding member 54. In particular, preferably, each hook 24 is inserted inside a sliding seat 58 formed in a corresponding protruding element 54.

Each surface 45 is arranged transversely inside the corresponding spline 57. This protects the sliding members 24 and strengthens the structure.

The locking members or hooks 24 are movable between a first locking position and a second unlocking position (for example shown in FIGS. 2 and 3, respectively), by means of manual operation of an actuating or operating member 26. Advantageously, the actuating member 26 acts, via its suitable shaped or cam surfaces, on the sliding hooks 24, as will become clear below. The actuating member 26 is movable with respect to the locking members or hooks (24).

In accordance with a possible embodiment of the present invention, each of the locking members or hooks 24 is movable with a first movement between the first locking position and the second unlocking position, and the actuating member 26 is movable with a second movement for the displacement of the locking members or hooks 24.

Advantageously, the first movement is different from the second movement. The first movement may be a slide movement. The second movement may be a rotation about the direction of axial extension of the gearmotor.

The actuating member 26 comprises advantageously at least one actuating end 28 which faces laterally the support 20 for easy manual operation thereof. In particular, the actuating ends 28 may be more than one, being distributed around the support 20, so that it is possible for the operator to reach easily at least one of them. Advantageously, the actuating ends 28 are four levers which are arranged at about 90° from each other.

As can be seen in FIGS. 2 and 3, according to a possible embodiment of the present invention, the hooks 24 have a U shape, with end arms 30 and 32 of the U which extend towards the axis ‘a’. The locking surface 43 is defined in the first end 30, while the actuating member 26 acts on the other end 32.

In accordance with a possible embodiment of the present invention, the support 20 comprises resilient means 34 which are suitable for pushing and retaining the hooks 24 towards the longitudinal axis ‘a’ of the support 12 and therefore towards their locking position.

Advantageously, said resilient means 34 consist of a resilient ring which surrounds the hooks 24 so as to push them radially. This ring is advantageously arranged concentric with the support 20, being preferably open and made of metal wire, and is inserted inside a groove 39 provided on the outer peripheral surface 36 of the support 20 and inside a seat 38 formed transversely on the outer surface of the hooks 24.

When the actuating member 26 is operated, the hooks 24 are pushed outwards, towards the unlocking position against the action of spring means 34, as shown for example in FIGS. 3 and 5.

Advantageously, the actuating member 26 is designed to be operated by means of rotation of an actuating end 28 about the axis ‘a’.

For this purpose, as can be clearly seen in FIGS. 4 and 5, advantageously the actuating member 26 has a body 29 of generally annular shape with radial projections having shaped or cam surfaces 44 on its outermost surface for pushing against the ends 32 of the hooks 24, when it is rotated about the axis ‘a’. In particular, the actuating member 26 may comprise a cam 44 for each hook 24.

The support 20 which receives the actuating member 26 may advantageously have a central seat 50 of circular shape with an edge protruding in the axial direction so as to form a circular rim 52 onto which the body 29 of the actuating member 26 can be externally fitted for rotation thereof. A small, outer, terminal rib on the end of the rim may prevent axial extraction of the operating member.

An axially protruding portion of the head 22 of the gearmotor 14 may be received inside the central seat 50, which may be formed hollow.

Arms 31 (advantageously curved so as not to interfere with the passage towards the fixing seats 48) protrude from the annular body 29 of the actuating member 26 in a generally radial direction and each terminate in an actuating end 28. In order to facilitate operation of the actuating member 26, the amplitude of rotation may also be very limited, owing to the particular kinematic mechanism chosen. For example, the curved section passed along by the actuating member 28 for release may be advantageously equivalent to about 10°.

The rotational travel is limited by the circumferential amplitude of seats 33 from which the actuating ends 28 project.

The profile of the cams 44 and, if necessary, the profile of the ends 32 of the hooks 24 on which the cams 44 slide may be designed with various configurations and geometrical forms depending on the specific operating mode desired and the specific movement path required for the hooks 24.

For example, the surface of each cam 44 may be designed, by means of a particular form-fit between the surfaces, so as to obtain a released position which, once reached, is stable.

Advantageously, this may be obtained, as shown in FIG. 6, by forming the cam surfaces and the ends of the hook 24 making contact with the cam 44 so that they are convex and concave, respectively. In this way, when the actuating member 26 is rotated into the released position of the hooks 24, the cams 44 remain lightly engaged with their cusps inside the ends 32 of the hooks 24. Subsequent manual operation of the actuating member 26 overcomes the resistance created by the form-fit and repositions the support 20 in the locked condition. This stable operating condition allows the user, for example, to extract the gearmotor from the support 20 using both hands after moving the actuating member 26 into the releasing/unlocking position.

Alternatively, the cam 44 may be designed so that the single stable position of the device is the locking position. For example, FIG. 7 shows a generally triangular configuration of the cam 44 so as to have an inclined-plane sliding surface without stable equilibrium points for the thrusting end of the corresponding hook 24. The inclination of the cam 44 will thus be chosen so that the force of the spring means 34 which act on the hooks 24 so as to push them towards the locking position causes backwards rotation of the actuating member 26 towards the locking position. In this way, it is certain that the actuating member 26 will be always be in the locking position except for those instances where the user operates it. This results in automatic resetting of the support device 20 and prevents accidental oversights where the device remains in the released/unlocking position. On the other hand, with automatic resetting the user must maintain the pushing force on the actuating member 26 with one hand, while with the other hand the head of the gearmotor is extracted from the support.

Advantageously, for mutual engagement of the support 20 and head 22, owing to the preferred structure shown, it is sufficient instead to move towards each other the two parts suitably rotated so that the projecting members 54 are inserted inside the splines 57.

By pushing further the two parts, the hooks 24 slide on the inclined teeth 42, retracting outwards so as to then click into the locking position at the end of the tooth. In order to facilitate sliding, the ends of the arms 30 may also be suitably inclined or shaped, as shown in the figures.

Alternatively, it is possible to perform actively displacement by moving the actuating member 26 so as to displace the hooks 24 into the released position, couple the support 20 and the head 22 and then bring the actuating member 26 back into the locking position so that the hooks 24 move again towards the axis ‘a’ so as to stop axial displacement of the head 22 with respect to the support 20.

At this point it is clear how the predefined objects have been reached, by providing a tubular gearmotor with a support 20 which has a simple and strong structure and a locking and unlocking mechanism which can be easily and quickly operated in any condition. Advantageously it does not require the use of external tools, excludes the need to perform several operations in succession, does not require necessarily the use of both hands and, advantageously, may be locked or unlocked also using only one finger.

Moreover, despite the strength and reliability, the structure may be kept very compact, in particular in the longitudinal direction, and advantageously kept within the transverse dimension of the gearmotor. It is also evident how the entire support may be made with few easy-to-assemble parts. The support may be formed by a single-piece moulded body with the actuating member snap-engaged and with the hooks inserted, being locked in position by the resilient ring. The second part which forms the head may be formed by a single moulded piece. Advantageously, all the parts of the support and the head (except for the resilient ring, which is preferably made of steel) may be plastic-moulded.

Obviously, the above description of an embodiment applying the innovative principles of the present invention is provided by way of example of these innovative principles and must therefore not be regarded as limiting the scope of the rights claimed herein.

For example, with regard to the embodiments described above, the person skilled in the art may, in order to satisfy specific requirements, make modifications to and/or replace elements described with equivalent elements, without thereby departing from the scope of the accompanying claims.

For example, the resilient ring 34 may be replaced by a spring for each engaging member. Moreover, although the structure with cam and spring means pressing on the hooks is particularly advantageous, it is also possible to consider using a mechanical actuating system applying a thrust in both directions, with the resilient member which acts directly on the operating member if automatic resetting is required or, also, without any resilient member if means for locking the actuating member in at least in the locking position are used. These alternative systems may be easily imagined by the person skilled in the art on the basis of the description of the invention provided here. The means for preventing rotation and the means for removable axial engagement may also be made using the same component.

1. Tubular gearmotor for one or more of curtains, shutters, and roller blinds, comprising:
an end head configured for being connected to a surface via a support, wherein the support is intended to be fixed to the surface and the head is intended for insertion in the support along an insertion direction substantially coinciding with an axial extension of the gearmotor, the support being provided with means preventing rotation of the head and with releasable-locking means preventing axial extraction of the head;
wherein the releasable-locking means comprise:
one of locking members or hooks circumferentially distributed around an axis for insertion of the head in the support and each movable between a locking position and an unlocking position; and
an actuating member movable with respect to said locking members or hooks, said actuating member, when manually operated, adapted to displace the locking members or hooks between the locking position and the unlocking position.

2. The tubular gearmotor of claim 1, wherein each of the locking members or hooks is movable with a first movement between the locking position and the unlocking position, whereby the actuating member is movable with a second movement for displacement of the locking members or hooks, the first movement being different from the second movement.

3. The tubular gearmotor of claim 2, wherein the first movement is a slide movement.

4. The tubular gearmotor of claim 2, wherein the second movement is a rotation about a direction of axial extension of the gearmotor.

5. The tubular gearmotor of claim 1, wherein said actuating member comprises shaped or cam surfaces suitable for displacing said locking members or hooks between said locking position and said unlocking position.

6. The tubular gearmotor of claim 1, wherein the means for preventing the rotation comprise protruding members, wherein the protruding members are arranged around the perimeter of the support, extend parallel to said axis so as to receive and contain laterally the head between the protruding members, and extend inwards so as to define surfaces locating against side walls of splines formed circumferentially around the head.

7. The tubular gearmotor of claim 6, wherein the locking members or hooks slide between the locking position and the unlocking position through the protruding members.

8. The tubular gearmotor of claim 1, wherein said locking members or hooks are suitable for moving in a radial direction between said locking position and said unlocking position.

9. The tubular gearmotor of claim 1, wherein said locking members or hooks have a U shape with end legs pointing toward longitudinal axis of the support, with a first of the end legs forming a movable tooth which defines a locking surface and the actuating member acting on a second of the end legs.

10. The tubular gearmotor of claim 1, further comprising spring means suitable for pushing the locking members or hooks toward the locking position in a radical direction with respect to longitudinal axis of the support.

11. The tubular gearmotor of claim 10, wherein the spring means are formed by a resilient ring perimetrally surrounding the locking members or hooks.

12. The tubular gearmotor of claim 5, wherein said shaped or cam surfaces act on second ends of the locking members or hooks.

13. The tubular gearmotor of claim 1, wherein said support receives the actuating member rotatably with respect to said insertion axis so as perform, when rotated, displacement of the locking members or hooks between the locking position and the unlocking position.

14. The tubular gearmotor of claim 13, wherein said support has a central seat of circular shape with an edge protruding in axial direction so as to form a circular rim on which the actuating member is fitted externally so as to define a pivot for rotation thereof.

15. The tubular gearmotor of claim 1, wherein said actuating member is arranged with an annular body from which legs terminating outside the support, and wherein each leg has an actuating end protruding in a radial direction.
